(19) United States
(12) Patent Application Publication
(10) Pub. No.: US 2009/0290119 A1
(43) Pub. Date: Nov. 26, 2009

(54) Durable Eyewear Having Lens Cutouts

(76) Inventor: Thomas R. Bartholomew, San Antonio, TX (US)

Correspondence Address: Thomas R. Bartholomew, 711 Imlay, San Antonio, TX, 78209, US

(21) Appl. No.: 12/154,151

(22) Filed: May 21, 2008

(51) Int. Cl. G02C 5/16

(52) U.S. Cl. 351/114

(57) ABSTRACT

Eyewear which may be worn high up the bridge of the nose of a wearer and which simultaneously provides the wearer with the option of not needing to gaze through any lens material when peering straight ahead, by virtue of cutout regions disposed at the top portions of the lenses. Eyewear as provided overcomes problems of the prior art, including “popping out” of lenses from their frames in cases of framed lenses having cutouts, and also obviates lens breakage. The eyewear provided may comprise reading glasses, bi-focal lenses, and tri-focal lenses.

### TECHNICAL FIELD

This disclosure relates generally to eyewear. More particularly, it relates to eyewear useful for magnifying, such as reading glasses and prescription lenses.

### BACKGROUND

Spectacles and other eyewear featuring corrective optical lenses have been in widespread use for quite some time, with great benefits for nearly all who wear them. It is not uncommon however, for a wearer of reading glasses or other eyewear to wear their glasses in a position that is low on their nose, to facilitate the person's ability to circumvent peering through the corrective lenses on some occasions. For example, when a person who only uses reading glasses for reading fine print is confronted by a visitor to their office, they often do not remove their glasses but rather, having been wearing them low on their nose, merely peer over the top of the lenses to view the visitor. This typically requires cocking one's head downwardly, as well as becoming comfortable with wearing glasses low on one's nose, if such activity is to practiced as a routine, which many do indeed practice.

### SUMMARY OF THE DISCLOSURE

Articles suitable for use as eyewear which comprise a first lens and a second lens, each lens having an inside surface, an outside surface, and top portion, and a cutout region located at its top portion. There is a bridge portion having a first end portion and a second end portion, wherein the first end portion of the bridge portion is attached to the first lens and wherein the second end portion of the bridge portion is attached to the second lens. There is a first sidebar and a second sidebar, wherein the first sidebar is attached to the first lens and wherein the second sidebar is attached to the second lens. The sidebars possess an effective amount of flexibility to prevent forces sufficient for cracking either of said lenses from being delivered to said lenses solely through either of the sidebars.

### BRIEF DESCRIPTION OF THE DRAWINGS

In the annexed drawings:

FIG. 1 shows a perspective view of an article of eyewear according to one embodiment of the disclosure;

FIG. 2 shows a perspective view of a lens useful in providing an article of eyewear according to one embodiment of the disclosure;

FIG. 3a shows a perspective view of a gripping pad—sidebar assembly useful in providing an article of eyewear according to one embodiment of the disclosure;

FIG. 3b shows an alternate perspective view of a gripping pad—sidebar assembly useful in providing an article of eyewear according to one embodiment of the disclosure;

FIG. 4 shows a sectional view of a mounting arrangement for a gripping pad to be mounted to a lens in providing an article of eyewear according to one embodiment of the disclosure;

FIG. 5 shows a sectional view of an alternate mounting arrangement for a gripping pad to be mounted to a lens in providing an article of eyewear according to one embodiment of the disclosure;

FIG. 6 shows various embodiments of lens shapes useful in providing an article of eyewear according to one embodiment of the disclosure;

FIG. 7 shows a side perspective view of a section of a sidebar useful in providing an article of eyewear according to the disclosure;

FIG. 8 shows an overhead view of an article of eyewear according to one embodiment of the disclosure; and

FIG. 9 shows an overhead view of an article of eyewear according to another embodiment of the disclosure.

### DETAILED DESCRIPTION

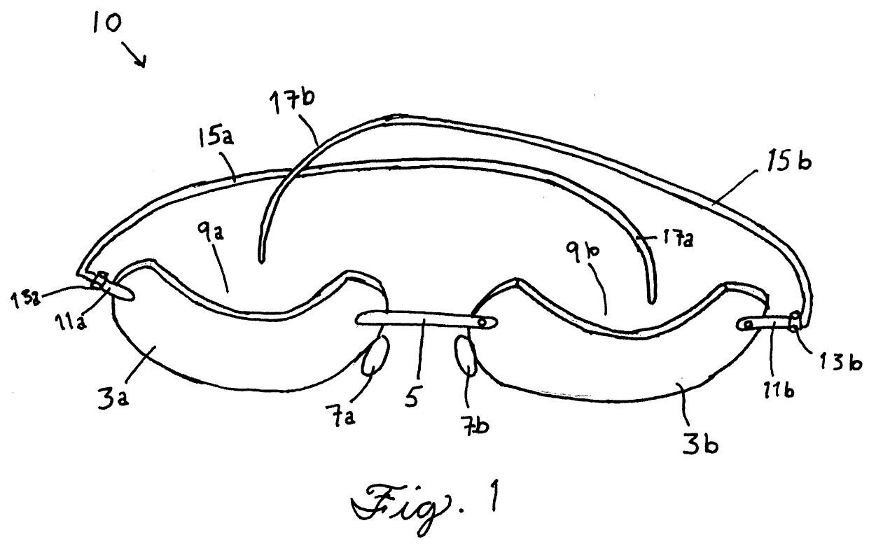

Referring to the drawings and initially to FIG. 1 there is shown a perspective view of an article of eyewear 10 according to one embodiment of the disclosure. In this FIG. 1 the eyewear 10 comprises two lenses 3a, 3b, which are connected to one another in the arrangement as shown via a bridge 5. Each lens 3a, 3b in one embodiment is provided with nose riders 7a, 7b affixed to them, which nose riders 7a, 7b are intended to contact the nose of a wearer of an article of eyewear 10 provided herein when in use, as is generally known in the art. The nose riders 7a, 7b in general are tiny pads and may be attached using conventional adhesives or other fastening means described herein. Any known materials and nose riders known in the art may be used as an element of eyewear 10 provided herein. In this embodiment the lens 3a also has attached to its surface a griping pad 11a, which includes a hinge 13a to which hinge 13a is attached a sidebar 15a having a bend 17a. The sidebar 15a is intended to ride on the ear of a wearer, and the bend 17a is intended to grip or hook the ear of the wearer, as such features are known in the art. The lens 3b also has attached to its surface a griping pad 11b, which includes a hinge 13b to which hinge 13b is attached a sidebar 15b having a bend 17b. The sidebar 15b is intended to ride on the ear of a wearer, and the bend 17b is intended to grip or hook the ear of the wearer, as such features are known in the art. The hinges 13a and 13b enable the sidebars to be folded when the eyewear 10 is not in use. However, in another embodiment the sidebars 15a and 15b are directly attached to their respective lenses without a hinge being present. In one embodiment the end portion of either or both sidebars are affixed directly to their respective lenses, and in another embodiment the end portions of the sidebars are attached directly to a gripping pad 11 without hinges being present.

The lenses 3a, 3b are each contoured to provide cutouts 9a, 9b which are regions at the top portion of each lens where some of the lens material has been removed, to enable a wearer of the eyewear 10 to look in a direction straight in front of them without any lens material being in their direct line of vision. Thus, in some embodiments the lenses and/or the cutout regions are of sufficient dimensions to enable the wearer of the eyewear 10 to look straight ahead without having any lens material in their line-of-sight when the eyewear 10 is mounted on the wearer's face so that the lenses are disposed to be at their minimum possible distance from the wearer's eyes. This minimum possible distance occurs when the eyewear 10 is worn all the way up the bridge of the wearer's nose, (as opposed to being worn farther down the nose, as many persons often do with reading glasses and the like) the distance between the inner surface of the lenses and the wearer's eyes being maintained by the geometry of the bridge 5, which precludes the lenses from contacting the wearer's eyes, and generally keeps the inside surface of the lenses at a distance between 12 mm and 25 mm from the surface of the wearer's eyes. This has the advantage that when the eyewear 10 comprises, in one embodiment, a pair of “reading glasses”, the wearer need not adjust the position of the glasses on their face when focusing on an object that is not close up to them or within typical reading distance. They may just look straight ahead, using eyewear 10 as provided herein, and not have any lens material in their direct line-of-sight. However, in other embodiments, the eyewear 10 may comprise lenses other than reading lenses, including bi-focal lenses and tri-focal lenses.

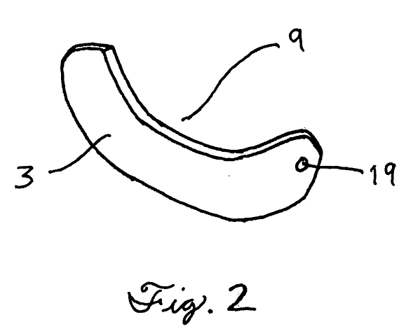

FIG. 2 shows a perspective view of a lens 3 useful in providing an article of eyewear according to one embodiment of the disclosure. In this embodiment, the lens 3 comprises a cutout 9 and may also comprise a hole 19 disposed through it, useful for affixing either a gripping pad 11a, 11b, (FIG. 1) or the bridge 5 (FIG. 1) to the lens 3 as later described. The lens may be comprised of any material known in the art from which optical lenses may be made, including without limitation glass, polycarbonates, and other polymers. In a preferred embodiment, the lenses are polycarbonate plastic.

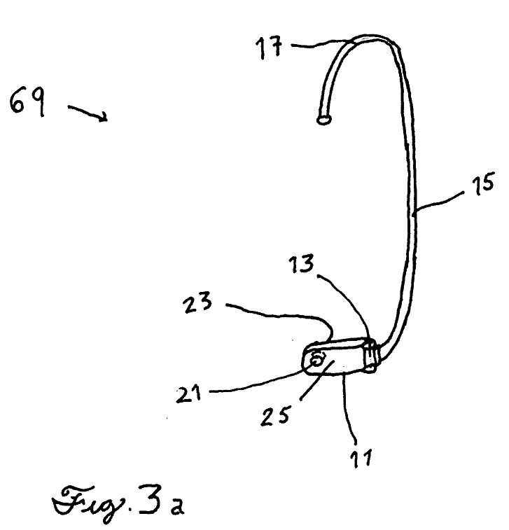

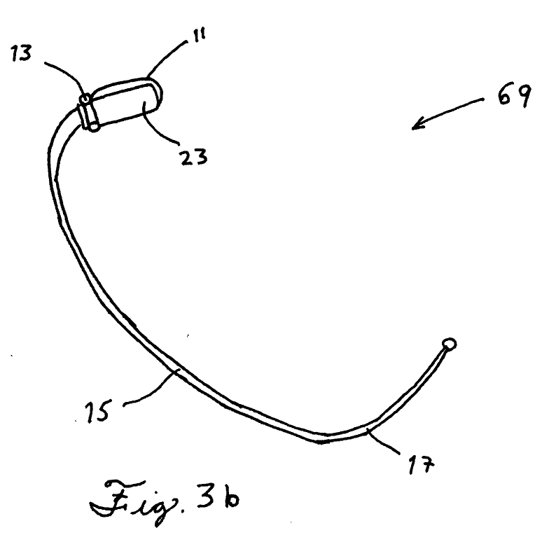

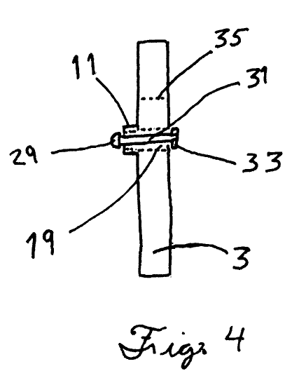

FIG. 3a shows a perspective view of a gripping pad—sidebar assembly 69 useful in providing an article of eyewear 10 according to one embodiment of the disclosure. The gripping pad 11 may be exist in any shape and is essentially a solid wedge, section, or piece of stock having a flat surface that is capable of substantially mating with or residing flush up against a lens 3a, 3b (FIG. 1). In one embodiment, the gripping pad 11 preferably has the shape of a rectangular solid and is comprised of a polymeric material, such as a polyolefin; however, any other polymeric materials such as acrylate polymers, vinyl acetate polymers and copolymers, urethanes, ABS, etc. are suitable. In fact, any polymer or other material known to be useful in making eyewear may be used in providing any component of the eyewear 10 provided by the present disclosure. Thus, the gripping pad 11 may also be comprised of wood, composites, or metals and metallic alloys. Disposed on one of the surfaces, (in one embodiment on an end surface) or on a surface near an end portion of the gripping pad 11 is a hinge 13 to which is also attached a sidebar 15 having a bend 17. The hinge 13 may be attached to the sidebar 15 and gripping pad 11 by being affixed to these elements using conventional adhesives, conventional fasteners, or by having a portion of the hinge “cast-in” to the gripping pad 11 or end portion of the side bar 15. The hinged arrangement of the sidebar 15 to the gripping pad 11 enables both sidebars on a finished eyewear 10 provided herein to be folded when the eyewear is not in use. In one embodiment, the gripping pad also has a rear surface 23 and a front surface 25. The sidebar 15 may be provided as having any cross-section, with circular and ovoid cross sections being preferred. The sidebar 15 is preferably dimensioned to have a thickness between about 1 millimeter (“mm”) and 5 mm, with a thickness of about 2 mm being preferred. Both sidebars 15a and 15b (FIG. 1) are preferably very flexible but have a memory, and can be bent quite readily in an arc of 180° with less than one pound of force and return to their original shape upon being released. In one embodiment, the rear surface 23 and front surface 25 are substantially flat. In another embodiment, the rear surface 23 is concave and front surface 25 is convex. In another embodiment, the rear surface 23 is convex and front surface 25 is concave. In one embodiment, there is a hole 21 disposed through the gripping pad 11 which enables it to be affixed to a lens 3 (FIG. 2) by means of a conventional fastener (FIG. 4). FIG. 3b shows an alternate perspective view of a gripping pad—sidebar assembly 69 useful in providing an article of eyewear 10 according to one embodiment of the disclosure. In FIG. 3b there are shown the respective locations of the gripping pad 11, the rear surface 23 of the gripping pad 11, the hinge 13, sidebar 15 having optional bend 17.

FIG. 4 shows a sectional view of a mounting arrangement for a gripping pad 11 to be mounted to a lens 3 in providing an article of eyewear 10 according to one embodiment of the disclosure. In this FIG. 4 there is shown the lens 3 having a hole 19 disposed through it as previously depicted in FIG. 2. The gripping pad 11 having hole 21 (FIG. 3a) disposed through it is shown for simplicity's sake without its corresponding hinge and sidebar attached. In this embodiment, the gripping pad 11 is affixed to the lens 3 by means of a conventional fastener comprising a head 29 and a shank 31 having threads on its outer surface (not shown). There is a complementary fastener 33, which may be a nut that is engaged on threads present on the shank 31 of the fastener. Thus, in one embodiment, the gripping pad 11 is affixed to the lens 3 by means of a fastener that is disposed in a bore that is comprised of the hole 21 in the gripping pad and a hole 19 in the lens. Other fasteners may be employed in this fashion, including rivets and tapered screws, such as machine screws, thus obviating the need for the complementary fastener 33. In another embodiment, the inner surface of the hole 19 itself comprises threads which are complementary to those present on the exterior surface of the shank 31 to enable the fastener to engage with the lens 3 itself. The lowermost point of the cutout 9 is shown by the dashed line 35.

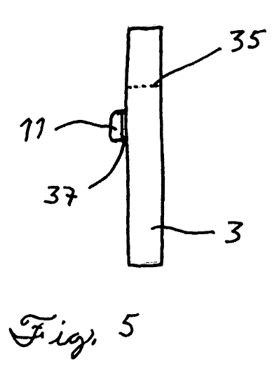

FIG. 5 shows a sectional view of an alternate mounting arrangement for a gripping pad 11 to be mounted to a lens 3 in providing an article of eyewear 10 according to one embodiment of the disclosure. In FIG. 5 is shown lens 3, and again the gripping pad 11 is shown for simplicity's sake without its corresponding hinge and sidebar attached. In this embodiment, the gripping pad 11 is affixed to one surface of the lens by means of an adhesive 37, which may be any known adhesive including without limitation epoxies, cyanoacrylates, solvent welds, thermowelding, etc. The lowermost point of the cutout 9 is shown by the dashed line 35.

In the embodiments shown in FIG. 4 and FIG. 5, the gripping pad, by virtue of its outer surfaces being capable of being constructed as either substantially flat, convex, or concave, may be affixed, as herein described or by other known fastening means, to a lens 3 either on the inside surface of the lens, or the outer surface of the lens, the inside surface being that closest to the eye of a wearer and the outside surface being that surface of the lens that is farthest from the wearer, when the eyewear 10 is worn as eyewear is normally worn about the face while in actual use.

The arrangements useful for affixing the gripping pad 11 to a lens 3 which were shown and described in relation to FIG. 4 and FIG. 5 and as otherwise described herein are also suitable arrangements for affixing the bridge 5 to the lenses 3a and 3b (FIG. 1). The bridge 5 may be comprised of the same materials as the gripping pads were described as being comprised. Any prior art eyewear bridge may be employed in alternate embodiments. Thus, the bridge 5 may be affixed to a lens 3 either by adhesives, or by a conventional fastener or fastening means disposed through holes through both the bridge 5 and lens 3 as was described in relation to the embodiments shown in FIG. 4 and FIG. 5 concerning attachment of a gripping pad 11 and lens 3 to one another.

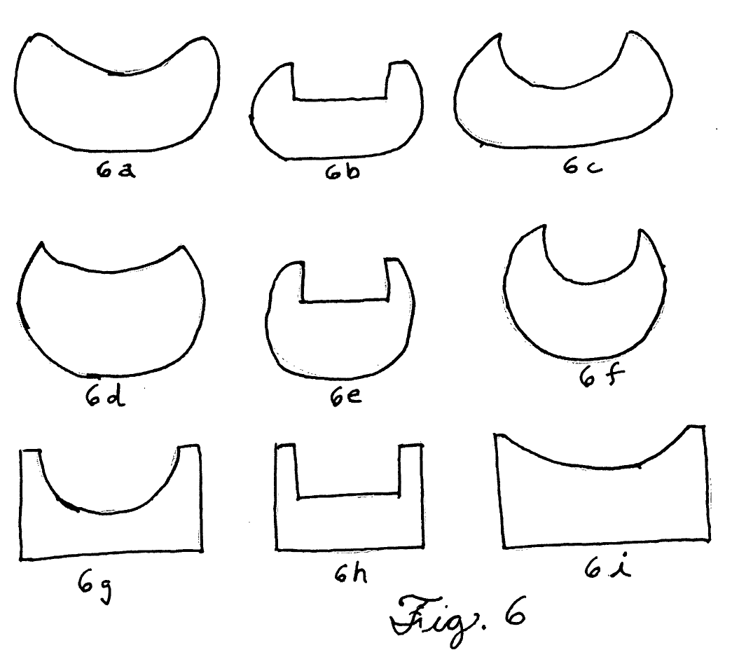

FIG. 6 shows various embodiments of lens shapes useful in providing an article of eyewear 10 according to one embodiment of the disclosure. The lenses depicted in FIGS. 6a, 6b, 6c, 6d, 6e, 6f, 6g, 6h, 6i are but a few possible lens shapes useful in accordance with eyewear provided by this disclosure, and shall not be construed as being delimitive hereof as one of ordinary skill readily recognizes that essentially any shaped lens may be employed, having essentially any shaped cutout 9 desired, provided that the lens shape and cutout enable a user to look in a straight direction while wearing eyewear 10 provided herein without having to glance through the actual lens, while wearing the eyewear 10. In FIGS. 6a, 6b, 6c are all substantially oval or ovoid in shape, while those of FIGS. 6d, 6e, 6f are circular or substantially circular in shape, while those in FIGS. 6g, 6h, and 6i are substantially rectangular in shape, and may include square shaped lenses. For each case of ovoid, circular, rectangular or other-shaped lenses, the cutout portions shown may themselves in each case be circular, ovoid, rectangular, among other shapes not shown, which may include all polygons, arcs, and combinations thereof.

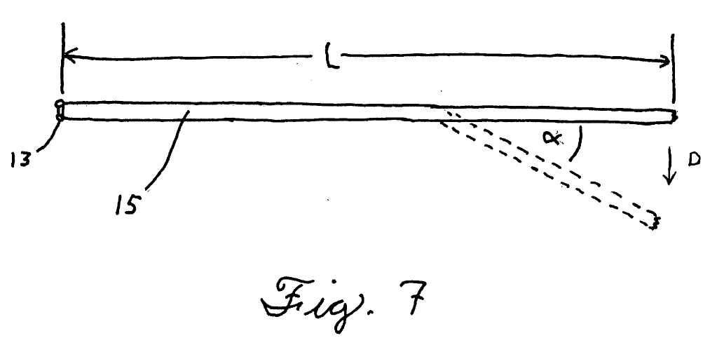

Those of ordinary skill having read this disclosure readily appreciate that the lenses 3a, 3b in eyewear 10 as provided in some embodiments herein do not comprise a frame which surrounds or co-extends the perimeter of the lenses, such as is the case with many pieces of eyewear found in the prior art. I have found that the use of metallic frames in eyewear 10 according to this disclosure along with rigid sidebars and bridge typically leads to the lenses unexpectedly being released from, or “popping out” of such frames, under normal conditions of use and/or storage of the eyewear, thus rendering them less durable and often unsuitable for use in the long-term. While not professing to know the reason for this tendency nor being bound to any single theory concerning same, it is suspected that the lens shape, particularly the cutout region, is a contributing factor to such failure. However, I have also found that even in cases where the lenses do not include frames (such as embodiments of eyewear shown in U.S. Pat. Nos. Des. 438,432 and Des. 206,685), when either of the sidebars and bridge, or both, are constructed of a substantially-rigid material, the lenses themselves in such eyewear are prone to breakage and cracking during normal conditions of use and storage. Hence, it has been a problem in the art to produce eyewear having lenses with cutout regions as herein provided, which are not problematic in one regard or another. I have nevertheless conceived and reduced to practice useful embodiments of such eyewear 10 in which the lenses are not prone to cracking and which suffer not from a propensity of the lenses popping out of their frames. This is accomplished by not utilizing a frame, and by employing a bridge and/or sidebars which are inherently flexible in an effective amount that prevents sufficient force necessary for a lens 3 to crack to ever be delivered to lens 3 upon any force being delivered to the sidebars or bridge, such as by actuating the hinges to which the sidebars are attached, or applying any forces to the sidebars or bridge. In one preferred embodiment, the sidebars 15a and 15b in an article of eyewear 10 as herein provided both are both flexible. In another embodiment, the bridge 5 in an article of eyewear 10 as herein provided is flexible. In yet another embodiment, the sidebars 15a and 15b and the bridge 5 in an article of eyewear 10 as herein provided both are all flexible. Typically, the sidebars 15 themselves have a length dimension, from the point at which they contact the hinge 13 to which they are attached at one end, to their other end at the bend 17, of between about 10 cm and 18 cm, depending on the degree of bend and style of the sidebar 15. FIG. 7 shows a side view of a section of a sidebar 15 according to one preferred embodiment, in which the substantially-linear portion of the sidebar 15 suitable for use herein will readily bend to an angle alpha of at least 30 degrees from linear, when a person holds the sidebar between the index finger and thumb of one hand at the first end of the sidebar 15 at the hinge 13, while their other hand holds the same sidebar between the thumb and index fingers at a point 15 centimeters away from the hinge (L=15 cm), and applies a force of thirty grams (0.3 Newtons) in a direction D, which direction D is perpendicular to the longest length dimension of the sidebar, as shown. In another embodiment, the substantially-linear portion of the sidebar 15 will readily bend to an angle alpha of at least 30 degrees from linear, when a person holds the sidebar between the index finger and thumb of one hand at the first end of the sidebar 15 at the hinge 13, while their other hand holds the same sidebar between the thumb and index fingers at a point 15 centimeters away from the hinge (L=15 cm), and applies a force of twenty five grams (0.25 Newtons) in a direction D, which direction D is perpendicular to the longest length dimension of the sidebar, as shown. In another embodiment, the substantially-linear portion of the sidebar 15 will readily bend to an angle alpha of at least 30 degrees from linear, when a person holds the sidebar between the index finger and thumb of one hand at the first end of the sidebar 15 at the hinge 13, while their other hand holds the same sidebar between the thumb and index fingers at a point 15 centimeters away from the hinge (L=15 cm), and applies a force of twenty grams (0.2 Newtons) in a direction D, which direction D is perpendicular to the longest length dimension of the sidebar, as shown. In another embodiment, the substantially-linear portion of the sidebar 15 will readily bend to an angle alpha of at least 30 degrees from linear, when a person holds the sidebar between the index finger and thumb of one hand at the first end of the sidebar 15 at the hinge 13, while their other hand holds the same sidebar between the thumb and index fingers at a point 10 centimeters away from the hinge (L=10 cm), and applies a force of thirty grams (0.3 Newtons) in a direction D, which direction D is perpendicular to the longest length dimension of the sidebar, as shown. In another embodiment, the substantially-linear portion of the sidebar 15 will readily bend to an angle alpha of at least 30 degrees from linear, when a person holds the sidebar between the index finger and thumb of one hand at the first end of the sidebar 15 at the hinge 13, while their other hand holds the same sidebar between the thumb and index fingers at a point 10 centimeters away from the hinge (L=10 cm), and applies a force of twenty five grams (0.25 Newtons) in a direction D, which direction D is perpendicular to the longest length dimension of the sidebar, as shown. In another embodiment, the substantially-linear portion of the sidebar 15 will readily bend to an angle alpha of at least 30 degrees from linear, when a person holds the sidebar between the index finger and thumb of one hand at the first end of the sidebar 15 at the hinge 13, while their other hand holds the same sidebar between the thumb and index fingers at a point 10 centimeters away from the hinge (L=10 cm), and applies a force of twenty grams (0.2 Newtons) in a direction D, which direction D is perpendicular to the longest length dimension of the sidebar, as shown. However, in each of the following examples above, it is necessary for the sidebar to have sufficient rigidity to maintain the eyewear 10 in position about the head of a wearer.

Suitable frames useful in accordance with the present disclosure include, without limitation, those available under the tradename Silhouette, available from Silhouette Optical, LTD., 260 Canon Street, Green Island, N.Y. 12183 and Canadian Optical Supply LTD. Of 8360 Mayrand Street, Montreal, Quebec N4P-2C9 and include frame models 7395 chassis, 7534 chassis, 1920 chassis, 7628 chassis, 7550 chassis, 7473 chassis, 7527 chassis, 6628 chassis, 7510 chassis, 7545 chassis, and 2863 chassis. Suitable frames useful in accordance with the present disclosure also include those available under the tradename ACCUFLEX™ 162/01 including FLEXON™ 135, a shape memory alloy of titanium, available from Marchon Eyewear of Melville, N.Y. However, sidebars useful herein may be comprised of any material or composite which possesses an effective amount of flexibility to preclude the lenses from cracking under conditions of normal use, wear, and tear, while also possessing sufficient rigidity to maintain the eyewear on the head of the user. Various materials are useful towards such end, within wide ranges of Youngs Modulus values, since a wide range of diameters and cross sections for the sidebars may be employed, and they may be reinforced with various materials. For example, ethylene vinylacetate copolymers having very high melt flow rates can be suitably employed if internally reinforced with very thin strands of metallic wires, woven or non-woven and the diameter of the sidebars is of an appropriate thinness to provide flexibility suitable for preventing the lenses from cracking under conditions of normal use, wear, and tear. In any event, it is preferred that the sidebars possess an effective or sufficient amount of flexibility, to prevent forces sufficient for cracking either of the lenses from being delivered to said lenses solely through either of said sidebars. In one embodiment, the bridge possesses an effective amount of flexibility to prevent forces sufficient for cracking either of the lenses from being delivered to either of the lenses solely through the bridge.

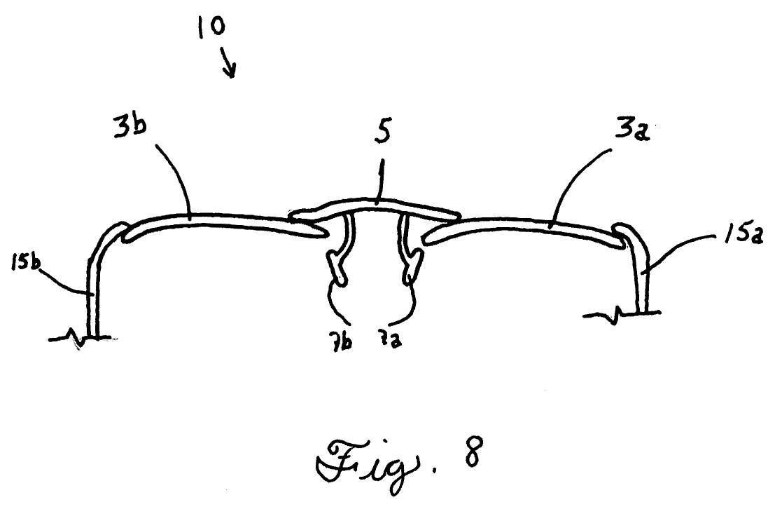

FIG. 8 shows an overhead view of an article of eyewear 10 according to one embodiment of the disclosure. In FIG. 8 are shown the respective locations of the lenses 3a, 3b, sidebars 15a, 15b, nose riders 7a, 7b, and bridge 5. In this embodiment, the bridge 5 is fastened to the individual lenses 3a, 3b by means of conventional adhesives, and the bridge includes the nose riders 7a, 7b being attached thereto, in one embodiment by a conventional adhesive. The sidebars 15a, 15b are attached directly to the lenses 3a, 3b themselves, by a conventional adhesive.

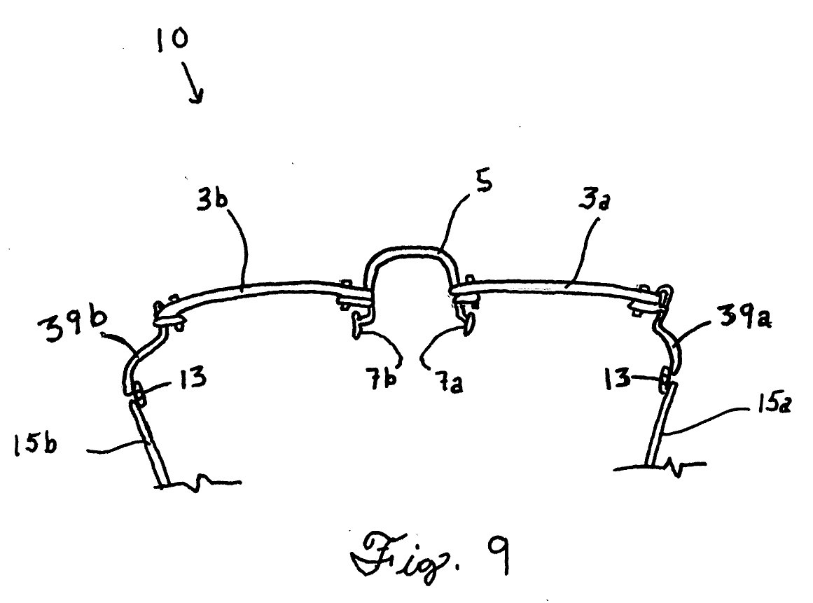

FIG. 9 shows an overhead view of an article of eyewear 10 according to another embodiment of the disclosure. In FIG. 9 are shown the respective locations of the lenses 3a, 3b, sidebars 15a, 15b, nose riders 7a, 7b, and bridge 5. In this embodiment, the bridge 5 is adhered to each of the lenses 3a, 3b by means of fasteners commonly disposed therethrough, which fasteners may include nuts and bolts, screws, and other conventional fasteners. The sidebars 15a, 15b are attached to the lenses 3a, 3b through hinges 13, which are also attached to auxiliary bars 39a, 39b, and the auxiliary bars are attached to lenses 3a, 3b by means of fasteners commonly disposed therethrough, which fasteners may include nuts and bolts, screws, and other conventional fasteners.

This disclosure has described certain preferred embodiments and modifications thereto. Further modifications and alterations may occur to others upon reading and understanding this disclosure. Therefore, it is intended that the disclosure not be limited to the particular embodiments(s) disclosed as the best mode contemplated for carrying out this disclosure, but that the disclosure will include all embodiments falling within the scope of the appended claims.

I claim:

1) An article suitable for use as eyewear which comprises:
a) a pair of lenses, each lens having an inside surface, an outside surface, and top portion, each lens further comprising a cutout region located at its top portion;
b) a bridge portion, said bridge being connected to each of said lenses; and
c) a pair of sidebars, each sidebar within said pair being attached to a different one of said lenses,
wherein said sidebars possess an effective amount of flexibility to prevent forces sufficient for cracking either of said lenses from being delivered to said lenses solely through either of said sidebars.

2) An article suitable for use as eyewear according to claim 1 wherein each of said sidebars are hingeably attached to a lens.

3) An article suitable for use as eyewear according to claim 1 wherein each of said sidebars are attached directly to a lens.

4) An article suitable for use as eyewear according to claim 1, wherein said lenses exist in a shape selected from the group consisting of: ovoid lenses, circular lenses, and rectangular lenses.

5) An article suitable for use as eyewear according to claim 1, wherein said cutout regions exist in a shape selected from the group consisting of: ovoid, circular, and rectangular cutouts.

6) An article suitable for use as eyewear according to claim 1, wherein said lenses exist in a shape selected from the group consisting of: ovoid lenses, circular lenses, and rectangular lenses and wherein said cutout regions exist in a shape selected from the group consisting of: ovoid, circular, and rectangular cutouts.

7) An article suitable for use as eyewear according to claim 1, wherein said lenses comprise mono-focal lenses.

8) An article suitable for use as eyewear according to claim 1, wherein said lenses comprise bi-focal lenses.

9) An article suitable for use as eyewear according to claim 1, wherein said lenses comprise tri-focal lenses.

10) An article suitable for use as eyewear according to claim 1, wherein said sidebars have an effective amount of flexural modulus suitable for maintaining said eyewear in a stationary position on the head of a wearer.

11) An article suitable for use as eyewear according to claim 1, wherein said cutout regions are of sufficient dimension to enable a wearer of said eyewear to peer straight ahead without having a substantial amount of lens material in their direct line-of-sight when said eyewear is mounted on the wearer's face, by virtue of the presence of said cutout regions.

12) An article suitable for use as eyewear according to claim 1, wherein said cutout regions and said lenses are of sufficient dimension to enable a wearer of said eyewear to peer straight ahead without having a substantial amount of lens material in their direct line-of-sight when said eyewear is mounted on the wearer's face, by virtue of the presence of said cutout regions.

13) An article suitable for use as eyewear according to claim 1, wherein there is no frame surrounding either of said lenses about their entire perimeter.

14) An article suitable for use as eyewear according to claim 1, wherein there is no frame surrounding either of said lenses along any portion of their perimeter.

15) An article suitable for use as eyewear according to claim 1 wherein at least one of said lenses includes a nose rider affixed to it.

16) An article suitable for use as eyewear according to claim 1 wherein said bridge portion includes at least one nose rider affixed to it.
